(19) United States
(12) Patent Application Publication
(10) Pub. No.: US 2011/0184771 A1
(43) Pub. Date: Jul. 28, 2011

(54) IMPLEMENTATION RESOURCE PROJECT MANAGEMENT

(76) Inventor: Robert Frances WELLS, Alpharetta, GA (US)

(21) Appl. No.: 12/974,196

(22) Filed: Dec. 21, 2010

Related U.S. Application Data
(60) Provisional application No. 61/298,976, filed on Jan. 28, 2010.

(51) Int. Cl. G06Q 10/00

(52) U.S. Cl. 705/7.14; 705/7.15

(57) ABSTRACT

A method and apparatus provides management of projects including breaking the project into tasks and task dependencies and assigning employees as resources to work on the task dependencies. Resources are evaluated based on skills, experience with applications, distance to work site, customer satisfaction rating of prior work and availability. Progress on the project is monitored by input of employee time into the system. Projected completion dates, start dates of subsequent projects and resource allocation is automatically determined as changes in project progress and resources occur.

### CROSS-REFERENCE TO RELATED APPLICATION

This application claims the benefit of U.S. Provisional Patent Application Ser. No. 61/298,976, filed Jan. 28, 2010, which is incorporated herein by reference.

### BACKGROUND OF THE INVENTION

1. Field of the Invention

The present invention relates generally to a method and apparatus for resource management, and more particularly to the automated presentation of available resources listed in the order of priority based upon the optimal criteria defined.

2. Description of the Related Art

The management of resources (personnel and/or equipment) for projects is planned using a project management software package. Projects are built upon the definition of phases and tasks that are interrelated in accomplishing a deliverable. An example of this is the installation of General Ledger software for companies. Project management packages require the user to build a project template and then assign users to the project. Providing a project manager a roadmap on the sequence in which activities are to occur by specified individuals within a defined time period and set of hours. Project management tools over the years have evolved in the ability to build complex relationships between project phases and tasks while building sophisticated tracking reports.

Related to the process of planning projects and monitoring the progress of assignments being completed, is a time tracking system. There are various products in the market today that allow organizations to track, report and bill employee time in delivering services to customers. Time tracking systems are oriented around the reporting of resource utilization, billable and non-billable activity for specific customer engagements.

There are products in the marketplace that offer a combination of project management functionality in building project templates and supporting the capability of allowing users to enter their time against assigned tasks for tracking and progress reporting purposes. These products are oriented as a project management tool that has a limited time tracking capability or the converse.

Typically project management and time tracking tools are either vertical software tools that function independent of each other or may interchange data, such as employee time spent on a specified task, or offer integrated functionality. The limitations with these tools is that they require a manager to manually estimate the availability of resources that are qualified to perform project tasks based upon assigned current projects and forecast data of completed assignments. Within a limited resource pool of up to approximately ten employees, this is a manageable task. As the pool grows to fifteen or more resources and/or projects, this requires a more complex and careful coordination of personnel with varying skills. It is difficult to manage this number of resources and make the most efficient use of their time. In conjunction with trying to schedule these resources in a time efficient manner, other factors need to be taken into consideration that creates inefficiencies in the use of resource time. Some examples are: the location of the resource and time/distance of travel to the customer site, current projects that are running behind or ahead of schedule that creates a downstream impact on other projects, tasks and resources.

### SUMMARY OF THE INVENTION

Embodiments of the present invention provide an organization's management team guidance in planning, allocating, deploying and monitoring the utilization of resources while measuring customer satisfaction and quality of work. Foundational to aspects of the invention is the development of project plans for the delivery of services. Within these project plans is the definition of required skills and domain knowledge to perform project assignments. When a project is assigned to a customer, the method according to the invention evaluates personnel within an organization through a matching algorithm running on its computer servers to identify those that are best qualified to deliver services based upon their skills, domain knowledge, closest proximity to the customer site, historical project quality installation and customer satisfaction scores. The method and apparatus of embodiments of the invention calculates project needs within the computer system and generates a prioritized list a user can view on their personal computer of resources in order from those that are the best fit for the project to those that meet minimal requirements based upon the following criteria; skills, application knowledge, customer proximity, historical project quality and customer satisfaction scores, using the desired start date (if provided) and/or the optimized resource utilization start date (compression of any unplanned or unproductive resource time between projects). The present method and apparatus tracks personnel time stored in its database in current and future projects ensuring the available resources are presented to the appropriate management that uses the system's guidance in assigning individuals to a project.

As the method and apparatus tracks personnel time against project assignments in its database and memory of its computer servers, it dynamically calculates the availability of these resources for future project assignments or potential timing conflict in subsequent assigned projects (e.g. project time run over in current project). The method and apparatus continually forecasts the project completion date using personnel recorded time entered by the users on their personal computer through the web based application and comparing it against the original allocated hours and calculated completion date. As the method and apparatus identifies risks in the planned use of resources through the algorithm the application is running on its server in memory (e.g. not available for upcoming assignments due to assignment time over run), it uses this information to create exception based notification to the appropriate management personnel. This information is displayed on a user's personal computer running the web based application, guiding the management personnel in determining what if any intervention is required to ensure resource time is managed in an optimal manner while meeting customer expectations.

The present method and apparatus ties together through the database in a cohesive and integrated manner project planning, resource deployment of personnel, time tracking within a project plan while measuring customer satisfaction with the project activity and measuring employee performance in meeting their required deadlines. The method and apparatus facilitates an automated process of having customer's sign-off on completed assignments and report performance metrics on a Likert scale regarding the personnel performing the assignments. The method and apparatus also allows customers through the web based application displayed on their personal computer to sign-off on completed assignments, comment on the performance of personnel and send messages directly to the appropriate management level. Therefore, they can confidentially convey their concerns or compliments regarding the quality of services.

The method and apparatus reports the financial performance of projects, forecasts revenue to be recognized across multiple projects for a defined period of time, identifies any differences between the forecast and projected revenue based upon completed project assignments through the data stored in its database and calculated running application(s) in memory on the servers. The method and apparatus also supports the reporting of personnel performance on a user's personal computer through the web based application reflecting the utilization of work hours, unplanned employee time, project performance in completing assignments on-time and customer satisfaction scores based upon assignment performance.

### BRIEF DESCRIPTION OF THE DRAWINGS

FIG. 1 is a schematic diagram showing a cloud computing environment in which a preferred embodiment of the present invention is deployed;

FIG. 2 is a schematic representation of a database stored on computer readable media including sets of data fields in the data mode according to the principles of the present invention;

FIG. 3 is a process flow chart illustrating the steps of adding customers, employees and creating projects to be managed for the customer according to the invention;

FIG. 4 is a block diagram illustrating a process flow chart for assigning a project to a customer and for identifying the best resources for the project including taking the project to completion;

FIG. 5 is a block diagram showing a process flow chart for re-assigning of resources involved in the project or modifying the project dates depending on resource availability, including taking the project to completion;

FIGS. 6a, 6b, and 6c are block diagrams illustrating the process flow of a first component of the invention that uses an algorithm to calculate the best fit and available resources for consideration in assignment to the project;

FIGS. 7a, 7b, 7c, 7d, and 7e are a block diagrams illustrating a process flow of a second component of the invention that uses an algorithm to calculate and factor-in additional project and/or resource time due to an employee's title and experience level that meets the minimum requirements to complete an assigned task though they may not be the optimal fit;

FIG. 8 is a block diagram illustrating a process flow of a third component of the invention wherein the software dynamically recalculates task dependencies, task and project completion dates based upon user time entry in performing task dependencies;

FIGS. 9a, 9b, and 9c are a block diagrams illustrating a process flow of a fourth component showing how a user identifies and sets-up project tasks requiring electronic sign-off completion and customer satisfaction scoring of the task;

FIG. 10 is a block diagram illustrating the invention's process flow of a component for assigning a project quality score to a user as they complete assigned task dependencies;

FIG. 11 is a schematic representation illustrating that the present method and apparatus uses parameters defined in a project plan template (application knowledge, skill set requirements, etc.) to apply an evaluation algorithm to the pool of employees to identify the resources that meet the requirements and can be assigned to a project;

FIGS. 12a, 12b, and 12c are schematic representations illustrating that the present method and apparatus uses data in the database tables to evaluate the pool of employee resources and associated qualities (skill set, application knowledge, zip/postal code, etc.) relevant for comparison against customer project staffing requirements, a customer project with the tasks, task dependencies and associated requirements (skill set, application, etc.) and the customer project with tasks, task deficiencies and the associated resource candidates identified by the application applying the evaluation criteria (skill set, application knowledge, date availability, etc.)

### DETAILED DESCRIPTION OF THE PREFERRED EMBODIMENTS

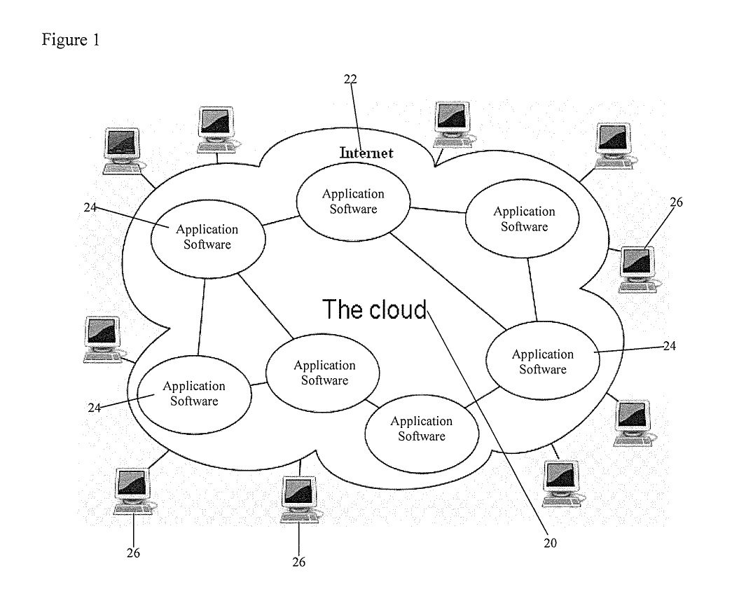

The present invention includes a method and apparatus that provides service based organizations the ability to manage multiple resources efficiently in the delivery of services to their customers. The primary mode of delivery is illustrated in FIG. 1 and referred to as cloud computing 20. The present method and apparatus is designed to run on either a cloud computing deployment or a turn-key environment installed on computer servers in a customer's facility (an Intranet deployment). Cloud computing 20 is an Internet-based application and use of computer technology where the software resides on one or multiple computer servers (not shown) physically connected to the Internet 22 or Intranet via computer network cables. Applications 24 run on the computer servers on the Internet 22 and display the functionality, accept data and present data to end-users on their personal computers 26 running a web browser. The applications 24 are built on a web based n-tier architecture. The n-tier architecture is a multi-tier software product architecture in which the presentation of the application screens, the application processing and the storage of the application data are logically separated processes that may run on a single computer server or on multiple computer servers networked together via computer network cables.

The underlying foundation of the embodiments of the present method and software is the web based application using the computational processing power of computer processes interacting with a data model designed to store information on the computer server that provides the associations between resources and project related information supporting the algorithms that drive the unique value of the present method and apparatus. This data model also provides the infrastructure of tracking resources and financial performance.

Another term used here includes user, who may be a representative of an organization that contracts the use of the described application to manage their employees in installing customer contracted application software or services. A customer may be an organization and/or user that has purchased the software and/or installation services. A project may be a series of steps that are a composition of installing a software application or a comprehensive service. A project is comprised of one or multiple tasks. A task may be an individual step that in combination makes up a project. A task is comprised of one or multiple task dependencies. A task dependency may be a detailed activity assigned to a task that has a resource assigned. To provide an example of the relationship between task dependencies and tasks is the following. A project is constructed of a series of tasks that define a deliverable product and/or service. An example of a task may be “site preparation” for a project installing a computer system and associated software at a customer site (e.g. accounts payable system). A subsequent project task dependent upon “site preparation” completion is “software installation”. The task dependencies that make up the task “site preparation” are comprised of detailed activities assigned to resources. The task dependencies for this task would include activities such as “site assessment” (evaluate power, network, storage space and cooling capacity) by an engineer. An example of another task dependency contingent on the completion of this activity would be “network design”. The completion of all task dependencies assigned to a task, in this example of “site preparation” will denote the completion of the task and the trigger mechanism for resources to start performing assigned activities within the next serial process step task. The resource is a person, for example that can have a skill set and application knowledge requirement associated with the project.

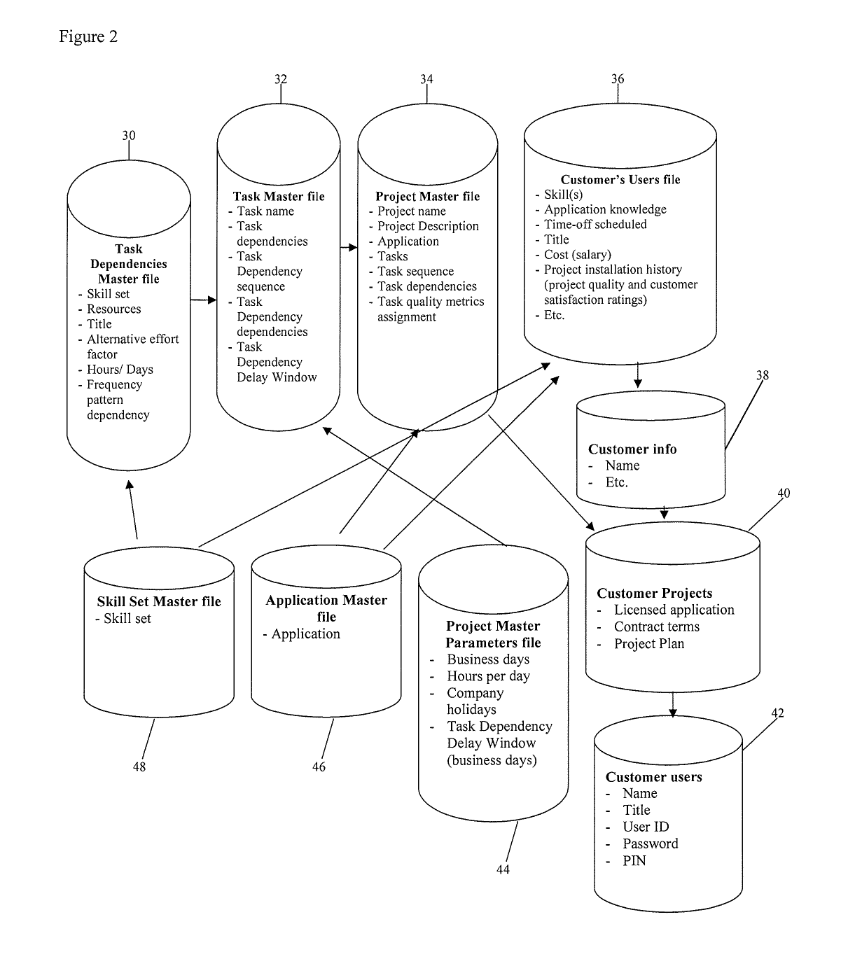

In FIG. 2, the data structures utilized in the present method and apparatus are illustrated showing the interrelationship between the files. An application data model sample set is shown. A database file 30 includes a task dependencies master file, which includes a skill set, information on resources, a title, an alternative effort factor, hour and days information, and a frequency pattern dependency. The database file 30 is connected to a database file 32 that is a task master file, which includes task names, task dependencies, task dependency sequences, task dependency dependencies and a task dependency delay window. The task dependency delay window is a time parameter that is used in evaluating the availability of resources to perform task dependencies. When a resource is evaluated by the application software algorithm for the availability to perform activities, the system compares the qualifying resource's skill set, application knowledge and availability against the dated range and duration of the task dependency to identify qualified resources. This task dependency delay window parameter precludes the elimination of any qualified resources that may appear unavailable due to scheduled time off. An example would be a resource that has personal time planned off that may appear to the system as not available to perform an activity. Whereas they may only be unavailable for a day or two within the duration of the task dependency time window. Therefore, the system will determine the acceptable level of delay in a task dependency that does not exclude a resource by comparing the resources days unavailable against this parameter. If the period of time a resource that is not available is equal to or less than the task dependency delay window value, they will still be considered and evaluated as a resource that can be assigned to the task dependency. The database file 32 is connected to a database file 34, which is a project master file. The project master file includes the project name, project description, application, tasks, task sequence, task dependencies and task quality metrics assignment.

At database file 36 is provided as a customer's users file, which includes information on skills, application knowledge, time-off scheduled, title, cost including possibly salary information, project installation history, possibly including project quality and customer satisfaction ratings, and other information as may be applicable. The database file is connected to a database file 38, which is a customer information file that includes the customer information and other information on the customer. The database file 38 is connected to a database file 40 that includes information on customer projects, including licensed application information, information on the contract terms and the project plan. The database file 40 receives information from the database file 34 and provides information to the database file 42, which is the customer users file. The customer users file includes the name, title, user ID, password and PIN number of the users of the customer.

A database file 44 is a project master parameters file, which is connected to provide information to the database file 32. The project master parameters file includes information on business days, hours per day that will be worked, company holidays and a task dependency delay window, which is preferably denoted in business days. A database file 46 is the application master file that includes the application. The database file 46 provides data to the database files 34 and 36. A database file 48 is provided as a skill set master in which is stored information on the skill sets of the workers. Of course, other database files and interrelationships between them may be provided.

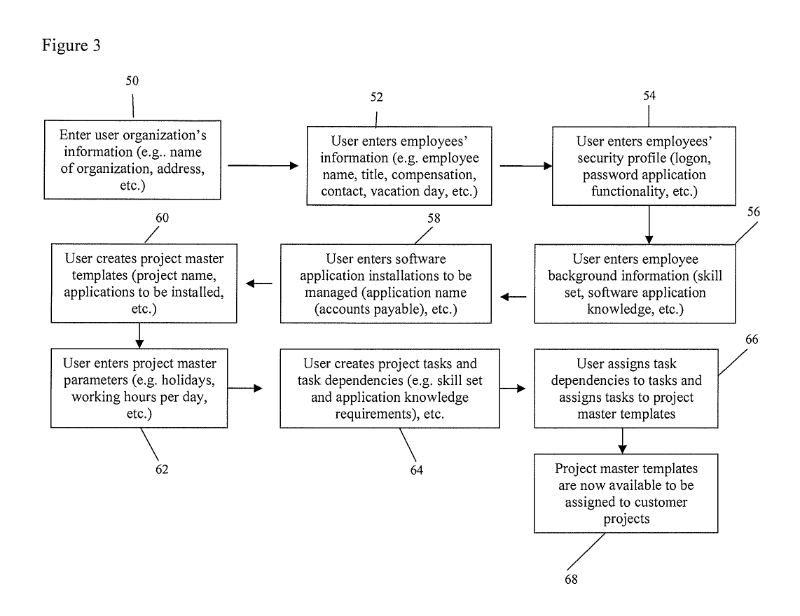

A process of creating customer information in the application is provided so that the customer may manage their projects. The process steps of building the required data is performed by one or more users on their personal computer running the web based application by guiding them in defining an organization, employee personnel, and project creation in the invention's data base model is illustrated in FIG. 3. In step 50, a user's organization information is entered. This may include the name of the organization, the address and other relevant information. A user interacts with the present software and apparatus through their personal computer running a web based application for entering their organization's information. Step 52 provides that the user enters the employees' information, including employee name, title, compensation, contact information, vacation days, and other information via the web based application. Step 54 calls for entry of the employees' security profile by the user, including log-in information, password application functionality, etc. The user at step 56 enters the employees' background information, which includes information on employee skill set, software application knowledge and other information. Entry of the software application installations to be managed is performed in step 58. This includes entry of the application name, which in the example is an accounts payable application, as well as other information.

After completion of the data entry steps, step 60 provides that the user creates a project master template, which includes project name, applications to be installed and other information. The project master parameters are entered in step 62. The parameter information may include information on holidays and working hours per day, etc. Next, the user creates project tasks and task dependencies, at step 64. This is performed using information on the skill sets and application knowledge requirements. In step 66, the user assigns task dependencies to tasks and assigns tasks to project master templates. At step 68, the project master templates are available to be assigned to the customer projects.

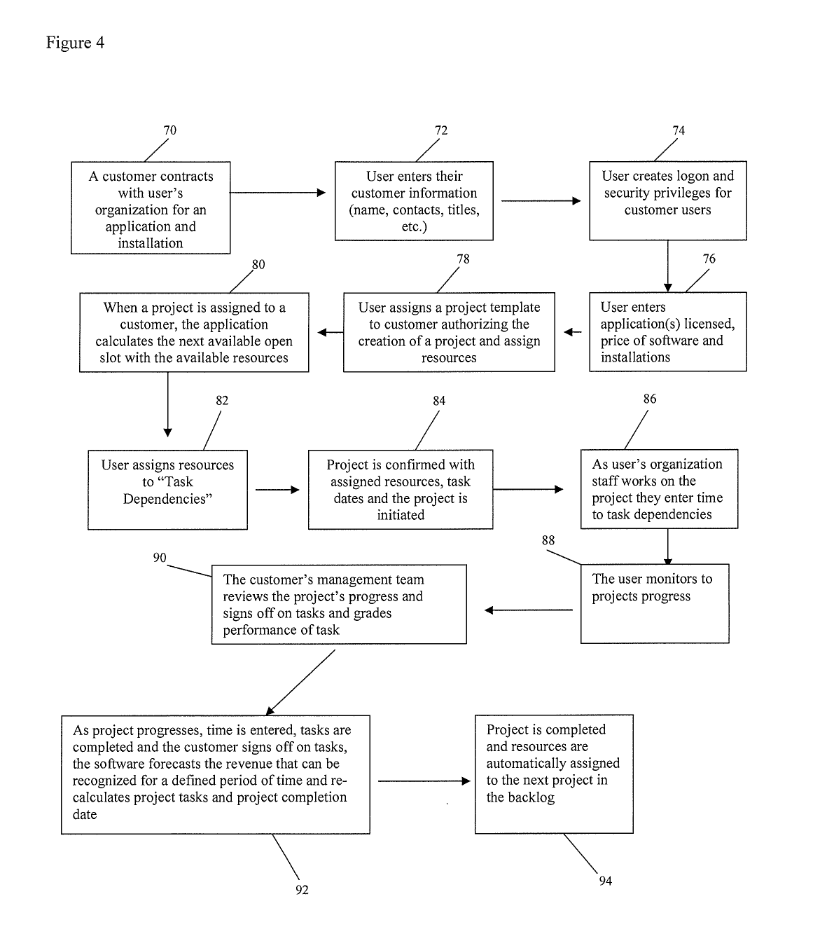

In FIG. 4, the process for assigning a project to a customer and for identifying the best resources for the project is provided. Once the perquisite data is built, an organization can assign a project to a customer, create the financial information associated with the project (e.g. price of software and applications purchased), create a time slot for the project, and guide the management in identifying the most appropriate personnel for project assignment. The process steps to perform these activities are outlined in FIG. 4. In step 70, a customer contracts with the user's organization for an application and installation. In step 72, the user enters their customer information (name, contacts, titles, etc.) through the web interface. Next, in step 74, the user creates a logon and security privileges for customer users through the web interface. The user enters application(s) that are licensed, the price of software and the installations at step 76. In step 78, the user assigns a project template to a customer, authorizing the creation of a project and the assignment of resources.

When a project is assigned to a customer, the application calculates the next available open slot with the available resources, according to step 80. In step 82, the user assigns resources to task dependencies. Step 84 provides that the project is confirmed with the assigned resources through the web based application, the task dates and the project is initiated. In step 86, as a user's organization staff works on the project they enter time to the task dependencies. As indicated in step 88, the system permits the user to monitor to project's progress. The customer's management team reviews the project's progress and signs off on tasks and grades the performance of the tasks, at step 90. In step 92, as the project progresses, time is entered, tasks are completed and the customer signs off on tasks. The software forecasts the revenue that can be recognized for a defined period of time and re-calculates project tasks and the project completion date. The project is completed in step 94 and the resources that were being used during the project are automatically transitioned to their next project and assignments in the queue.

Thus, the process of assigning personnel to work on a customer's project, entering their hours into the associated assignments on their personal computers running the web based application, and monitoring the progress of the project by the management team until its completion is outlined in FIG. 4.

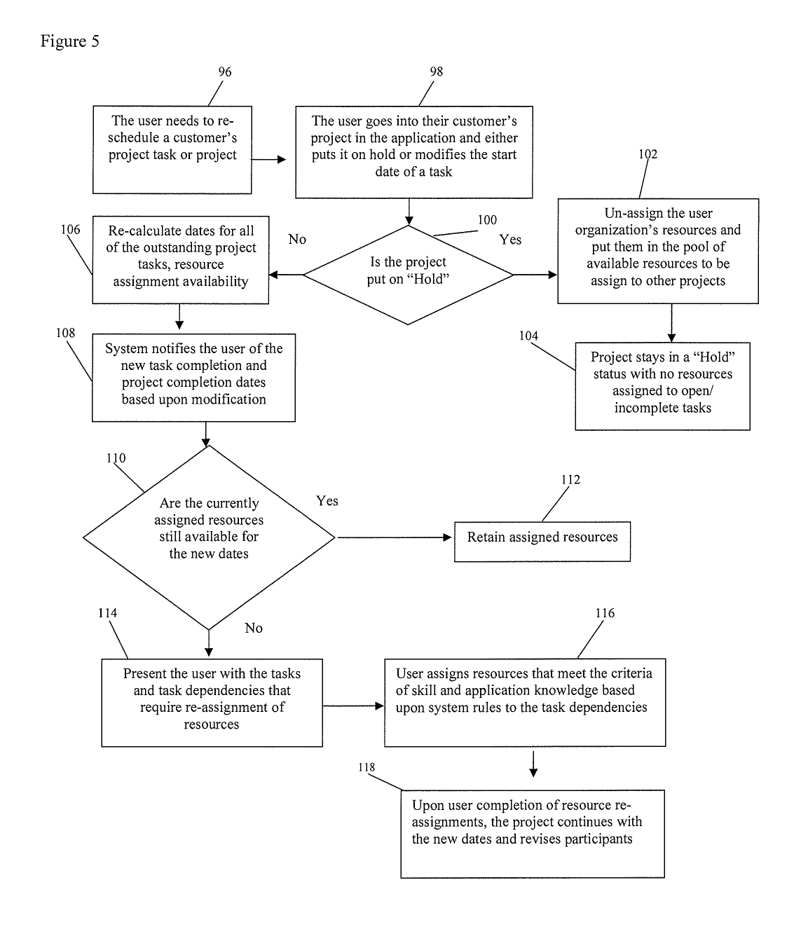

There are situations where a project's timelines may be modified or put on hold. FIG. 5 illustrates the process steps in the web based application software of how the present method supports the adjustment of resources and project timelines as unplanned circumstances occur, supporting the re-deployment of personnel to other projects. Resources are reassigned to another project and the project's due date may be modified due to changes in the project plan time frame. The system and method determines the next open window of time that has the resources available to work on the project. An embodiment of the invention includes a web based application software which is running on the computer server is continually monitoring the data stored in the server database to analyze current and planned assignment of resources to identify the best use of their time and fit as projects are presented to managers. This may be new projects or those requiring adjustments in their plans and resources. The method according embodiments of the invention guides the manager through the interaction of the web based application data delivered via a network connection to their personal computer in identifying the available personnel in the order of priority for project assignment.

In particular, FIG. 5 shows at step 96, that the user needs to re-schedule a customer's project task or project. In step 98, the user goes into their customer's project in the application and either puts the project on hold or modifies the start date of a task. A decision step 100 determines whether the project is to be put on hold or not. If so, step 102, un-assigns the user organization's resources that had been assigned to that project and put them in the pool of available resources to be assigned to other projects. At step 104, the project stays in a hold status with no resources assigned to its open and/or incomplete tasks. The project remains at this state until it is removed from hold.

If the decision 100 result is negative, the step 106 re-calculates the dates for all of the outstanding project tasks, and determines the resource assignment availability. The system notifies the user of the new task completion and project completion dates based upon modification or recalculation, at step 108. At decision step 110, an inquiry is made as to whether the currently assigned resources are still available for the new dates. If yes the resources are still available, at step 112, the assigned resources are retained. If not, at step 114, the user is presented with the tasks and task dependencies that require re-assignment to different resources. In step 116, the user assigns resources that meet the criteria of skill and application knowledge based upon system rules to the task dependencies. Moving to step 118, upon user completion of the resource re-assignments, the project continues with the new dates and revised the participants.

The process of FIG. 5 thus provides for re-assigning of resources to a project or modifying the project's dates due to project plan time frame changes in which the system identifies the next open window of time with resources available to work on the project.

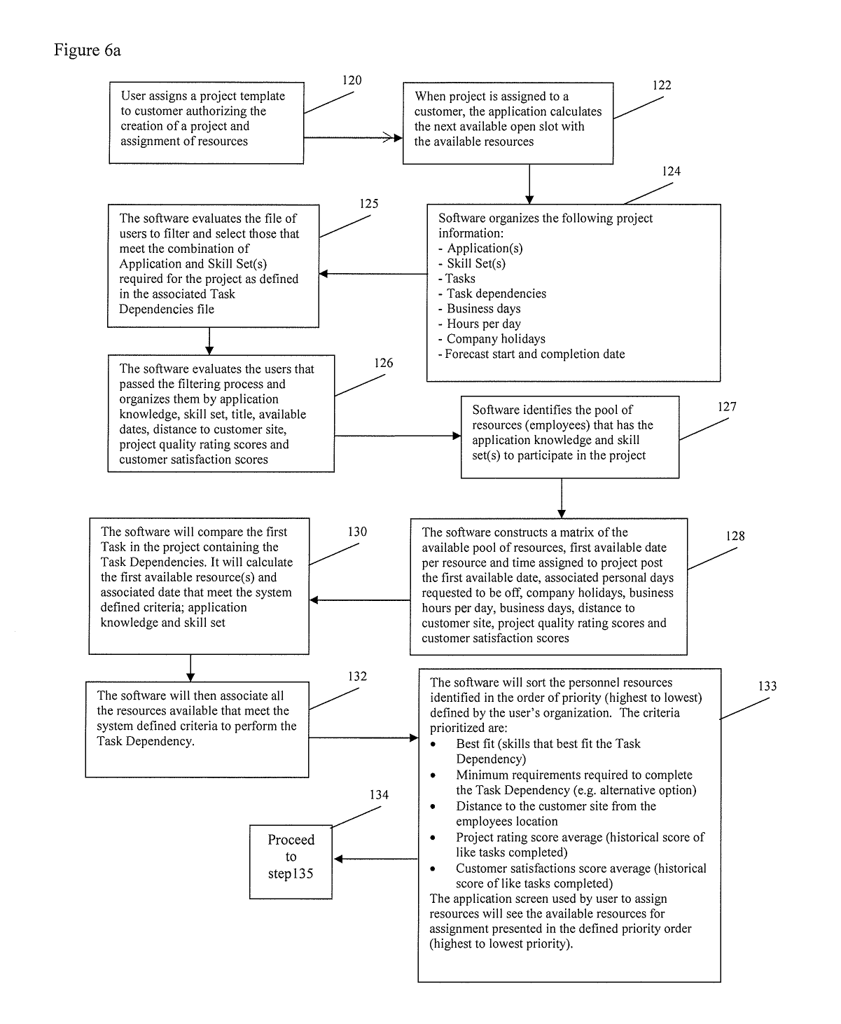

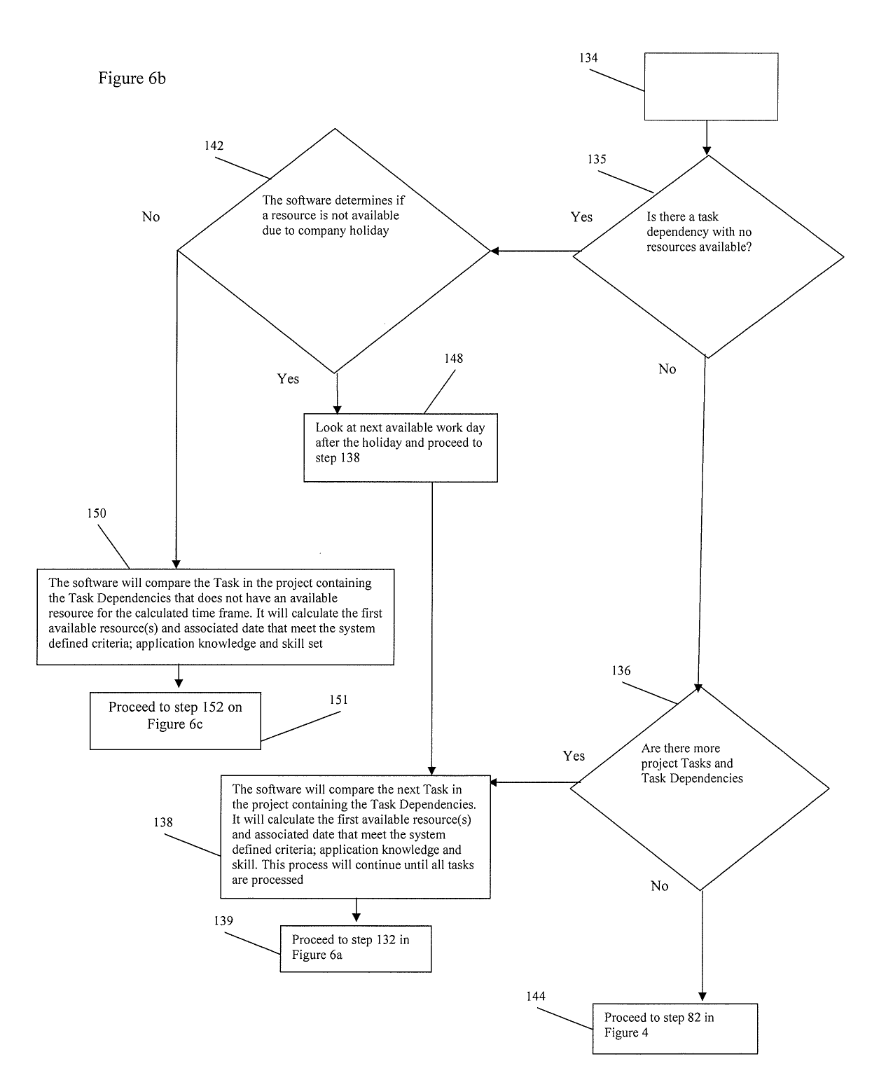

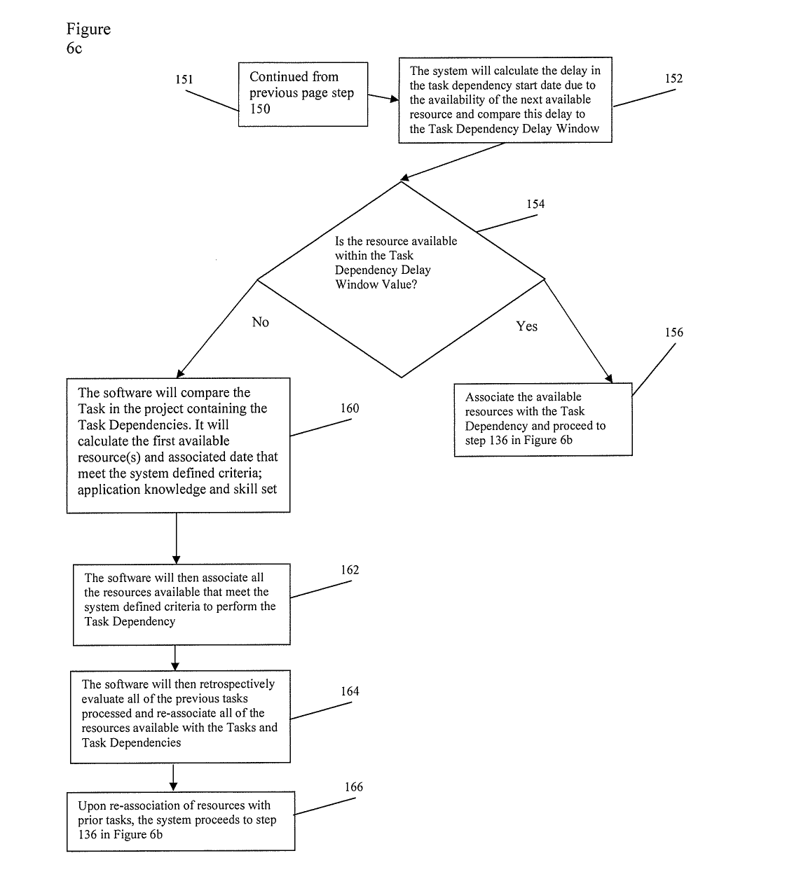

With reference to FIG. 6a, the first embodiment illustrated reflects the algorithm used to identify the best fit and available resources for consideration in assignment of the project. First, in step 120, the user assigns a project template to the customer, authorizing the creation of a project and assignment of resources. Next, in step 122, when the project is assigned to a customer, the application calculates the next available open slot with the available resources. In step 124, the software organizes the following project information: application(s) involved, skill set(s) of workers required, tasks to be performed, task dependencies, business days of the business, hours per day to be worked, company holidays, and forecast start and completion dates. Next in step 125, the software evaluates the file of the users and filtering and selecting those that meet the combination of application proficiency and skill sets that are required for the project as defined by the associated task dependencies file. In step 126, the software evaluates the users that passed the filtering process and organizes them by application knowledge, skill set, title, available dates, distance to customer site, project quality rating scores and customer satisfaction scores. The pool of resources is generated from the output of the evaluation and filtering steps. The software identifies the pool of resources (employees) that have the application knowledge and skill set(s) to participate in the project, at step 127. Next, at step 128, the software constructs a matrix of the available pool of resources, the first available date per resource and the time assigned to the project post the first available date, the associated personal days requested to be off, the company holidays, business hours per day, business days, the distance to the customer site, the project quality rating scores and the customer satisfaction scores.

Turning to step 130, the software will compare the first task in the project containing the task dependencies. It will calculate the first available resource(s) and associated date that meet the system defined criteria; application knowledge and skill set. In step 132, the software will then associate all the resources available that meet the system defined criteria to perform the task dependency. Next at step 133, the software will sort the personnel resources identified in the order of priority (highest to lowest) defined by the user's organization. The criteria prioritized are: best fit (skills that best fit the task dependency), minimum requirements required to complete the task dependency (e.g. alternative option), distance to the customer site from the employees location, project rating score average (historical score of like tasks completed), customer satisfactions score average (historical score of like tasks completed). The application screen used by the user to assign resources will see the available resources for assignment presented in the defined priority order (highest to lowest priority).

In FIG. 6b, the step 134 of FIG. 6a leads to step 135 where the decision is made as to whether there is a task dependency with no resources available. If no, an inquiry is made at step 136 as to whether there are more project tasks and task dependencies. If yes, at step 138, the software will compare the next task in the project containing the task dependencies. It will calculate the first available resource(s) and associated date that meet the system defined criteria; application knowledge and skill set. The next step 139 leads to step 132 in FIG. 6a. If the step 136 decision is no, the next step is 144 that leads to step 84 in FIG. 4.

In step 135, if the answer is yes, the process proceeds to a step 142 where the software determines if a resource is not available due to a company holiday. If yes, step 148 looks at the next available work day after the holiday and proceeds to step 138. If no, step 150 provides that the software will compare the task in the project containing the task dependencies that does not have an available resource for the calculated time frame. It will calculate the first available resource(s) and associated date that meet the system defined criteria; application knowledge and skill set. The next step 151 leads to step 152 on FIG. 6c.

In FIG. 6c, the step 151 of FIG. 6b leads to step 152, where the system will calculate the delay in the task dependency start date due to the availability of the next available resource and compare this delay to the task dependency delay window parameter value. In step 154, an inquiry is made as to whether the resource is available within the task dependency delay window value. If yes, then step 156 associates the available resources with the task dependency, after which the process proceeds to step 136 in FIG. 6b. If no, step 160 is where the software will compare the task in the project containing the task dependencies. It will calculate the first available resource(s) and associated date that meets the system defined criteria; application knowledge and skill set. Step 162 provides that the software will then associate all the resources available that meet the system defined criteria to perform the task dependency. Next, in step 164, the software retrospectively evaluates all of the previous tasks processed and re-associates all of the resources available with the tasks and task dependencies. In the following step 166, upon re-association of resources with prior tasks, the system proceeds with step 136 in FIG. 6b.

The computer system on which software for performing the present method is operating includes a user interface provided on a computer display as an application screen. The application screen used by the user to assign resources shows the available resources for assignment presented in the defined priority order (highest to lowest priority).

Referring to FIG. 2, the database file 36 contains data that customers enter into the application screen (which corresponds to step 56 of FIG. 3) defining their personnel used to deliver services with associated characteristics such as skill set(s) (e.g. network engineer) and application knowledge (e.g. accounts payable), scheduled time-off, location of employee (address, city, state, zip code), etc. Additionally the method and apparatus supports the functionality of allowing a customer to also load project installation history for each employee.

The method and apparatus utilizes the address and zip/postal code of each employee. It also stores the address and zip/postal code of the customer site. These two pieces of information allow the method and apparatus to calculate the proximity of employees that can performed the assigned task dependencies to the customer site requiring the services to be rendered.

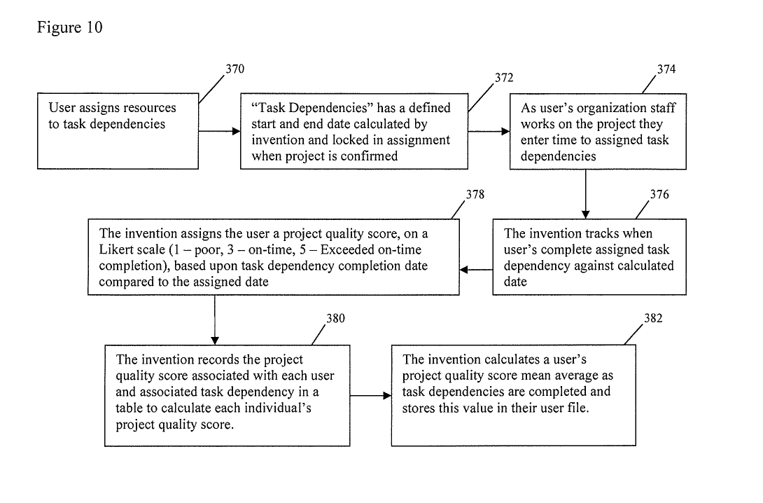

As each customer's employee works on a project and records their time on a personal computer running the web based application, the present software running on the computer servers over the Internet or intranet tracks in the database their performance in completing tasks on-time (project quality score) and records their performance using a Likert scale (shown FIG. 10). As each task dependency is completed by the employee, the method provides the functionality requesting customer's to rate their performance (customer satisfaction score) in completing the assignment. The rating scale presented to the customer is a Likert model with the lowest score (1) reflecting a poor performance and the highest score (5) reflecting an exceptional performance. The project quality and customer satisfaction scores are stored in each employee's data file. The present method utilizes the web based application software running on the computer server where the processing power of the server continually calculates the mean average of each score (project quality and customer satisfaction) and a combined mean average (overall performance score).

As each employee is defined in the method via the web based application displayed on a system administrator's personal computer connected to the computer server through a network connection to the Internet or intranet, their breadth of skills is associated with them. When a project plan template is created the skills required to perform the task dependencies are defined. If there are task dependencies that an individual can perform with a lower skill than the ideal skill level (e.g. associated network analyst III vs. network analyst II), the method supports the incorporation of additional time factoring in the experience for this individual. For example the task dependency planned resource time will be increased by 25% (defined in the project master template) allowing for the less experience of an associated Network Analyst III compared to a Network Analyst II in completing the assignment. This will adjust the completion date on the assigned task dependency, interrelated task dependencies and the project completion date.

As information is entered and calculated in the method (e.g. employee project quality score), this data stored on the application database on the server is used by the web based application in conjunction with the server processor(s) computational power to analyze the pool of employees that are a best fit for the assignment to a project. Project masters (or templates) are created within the method (see the project master data file 34 of FIG. 2) and designed around the services delivered by and organization. The hierarchy of projects is comprised of a project plan made up of tasks defined in the task master file (see the task master file 32 in FIG. 2). Each task is defined by one or multiple task dependencies (as shown in the task dependencies master file 30 in FIG. 2). Within the project master, the application knowledge requirement is defined. The task dependency has the required skill set defined for the assignment.

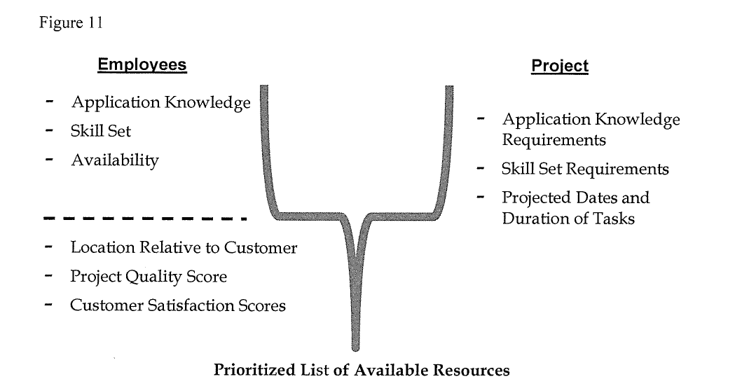

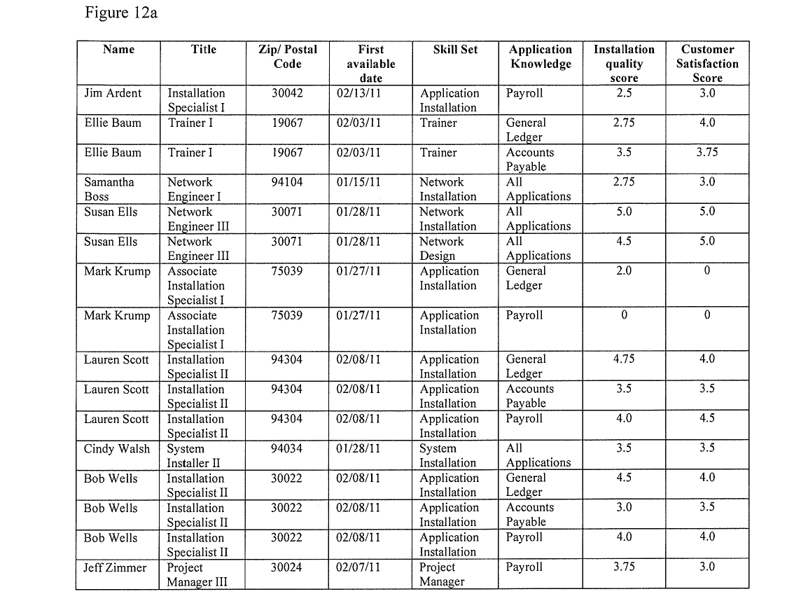

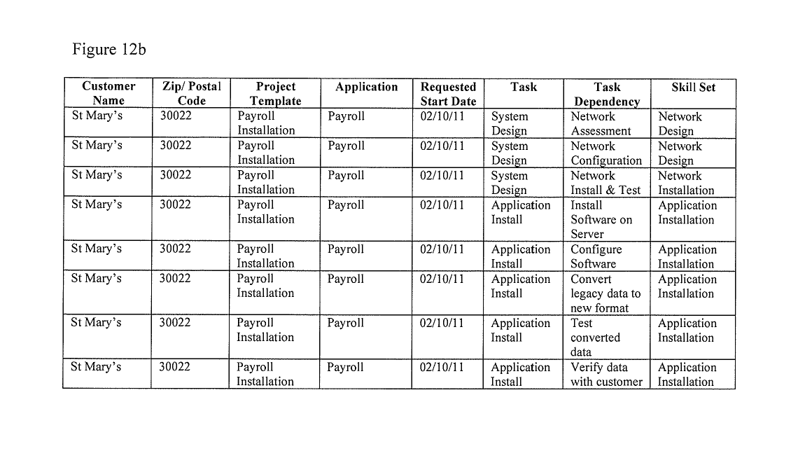

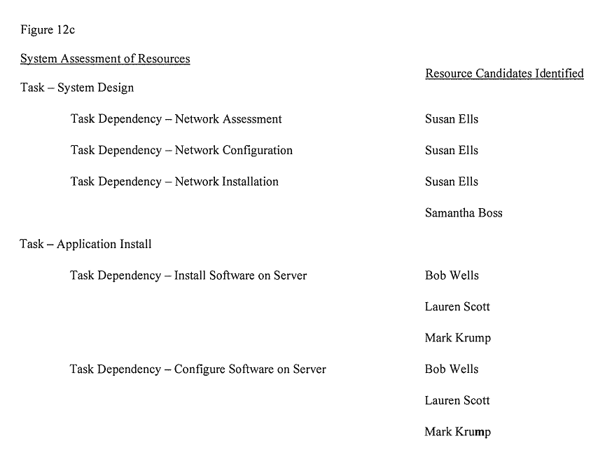

When a project master is assigned to a customer, the project is denoted in the system's database as a “pending” status. As a manager looks to assign resources to a customer project, the application looks at the requested start date. It also calculates the project start date optimizing the use of available resources (compressing the un-planned employee time between or within other projects). Based upon the desired start date, the application evaluates the information in its database tables and identifies the pool of resources that match the application knowledge and skill set necessary to perform the assignments and available for the calculated task dependency start dates and duration (see FIGS. 11, 12a, 12b, 12c). As the pool of resources is identified for each task dependency, the application sorts the list of resources based upon the order of priority defined by the manager. In the example outlined in FIG. 11, the resources are then presented in an order of priority using the criteria of employee that is physically located closest to the customer site where the services are to be rendered, the employee with the highest project quality score and the highest customer satisfaction score for the same type of project. This prioritization criterion (employee proximity to customer, project quality score and customer satisfaction score) may be changed dynamically by the manager assigning the resources.

Based upon this information processed by the web based application using the computational method on the data in the database stored on the computer server, the results are displayed on the user's personal computer via network connection to the Internet or intranet showing the sequence list of available resources to the manager by role. The manager selects the project team and submits the selection to the present method through their personal computer displaying the web based application connected via a network to the Internet or intranet. In this step the present method changes the project from a “pending” to a “confirmed” state in the database tables with the selected resources committed and scheduled for the project.

With reference to FIGS. 6a, 6b and 6c, a first embodiment is illustrated with the web based application software running on a centralized computer server which executes a proprietary algorithm that accesses the data stored in database tables on disk storage media connected to the server illustrated in FIG. 2 allowing it to calculate the best fit and available resources to be assigned to implementing a project.

The user is responsible for building the foundational information through the web based application running on their personal computer connected to the Internet or intranet to automate the calculation of resources available for possible assignment to project tasks comprised of task dependencies. The foundational information to support the web based application computational algorithm using the computer server processor(s) in automating the process of calculating the best fit available resources for an implementation project are the following database tables stored on the computer server.

A project master file 34 of FIG. 2 is a file containing the project plan templates containing the name(s) of the application(s) that will be installed (e.g. accounts payable application). The user can create an unlimited number of project master files through the web based application displayed on the user's personal computer via a network connection to the Internet or intranet. These project master files should be viewed as templates. They correlate with the types of software and service installation projects contracted to their customers and are required to plan the assignment of implementation personnel.

A task master file 32 of FIG. 2 that includes the tasks that are created and associated with a project through the web based application displayed on the user's personal computer via a network connection to the Internet or intranet.

A task dependencies master file 30 of FIG. 2 which includes the lowest levels of definable work activities. Within the task dependencies the skill set required to perform the task is assigned from the data entered in the skill set master file and the associated position title through the web based application displayed on the user's personal computer via a network connection to the Internet or intranet.

The users file 36 of FIG. 2 is a file that contains information about each user organization's employees. Within this file it identifies their application knowledge and skill sets through the web based application displayed on the user's personal computer via a network connection to the Internet or intranet.

A skill set master file 48 of FIG. 2 is a file that contains the information defining the skill sets required within an organization to implement applications and/or services. The skill sets are defined and entered by each user's organization and they are specific to that defining organization. This skill set is mapped to each user and task dependency. This is the data element in combination with application knowledge (defined in the application master file and associated to the user in the users file) that ensures the right users are mapped to the tasks they are qualified to perform through a combination of data filtering and matching based upon the rules of the web based application running on a computer server.

When a user has built the required data elements in the files listed above in the database tables stored on the server through the web based application displayed on the user's personal computer via a network connection to the Internet or intranet, they will then be able to assign a project to one or multiple customers. An example is that the user's organization sells financial system software. In this case, one of the modules sold is an accounts payable module. The user will have an accounts payable project plan master file (template) built with the requirements of the implementation personnel application knowledge and skill set(s) required for each unit of work defined in the task dependencies master file.

For example, let's say that the user wants to plan the installation of the accounts payable software post contract. The user will assign an accounts payable project template to the contracted customer identified in the application. The application takes the data submitted from the user's personal computer running the web based application through a network connection to the Internet or intranet will then automatically perform a computational analysis using a combination of the computer server processor and data stored in the database on the server to search the users file identifying the resources that meet the skill set and application knowledge requirements to perform the task dependencies in the project plan. The web based application will compute the data in the database server using the computer server processor in identifying the earliest available date of all the matching resources and start associating the resources with the task dependencies and project tasks. Also any employee planned time off is factored into determining which resources are available to perform task dependencies. Through this process of associating resources to the project, the method will calculate start and end dates for each project task and task dependency. Factored into the calculation of these dates is company holidays, working hours per day and working days per week. The system will automatically present the user with a list of resource requirements associated with the project. Next to each resource requirement on the display is a pull down box of the users available to work on the project.

The order of employees presented to the user is significant in the context of the system identifying which available employees are the best fit to those meeting the minimum requirements for the project assignment. The criteria used to present the order of employees from best fit to meeting minimal requirements are the following combinations. a) An employee has the skill set and application knowledge and position title combined that is the ideal fit for the task dependency assignment. b) An employee that lives closest to the customer site requiring the least amount of travel time and expense. c) An employee that has the highest quality score of project ratings for installations of the same type of project at prior customer sites. d) An employee that has the highest average customer satisfaction scores with the same type of project from prior customer installations. e) An employee that has the skill set and application knowledge sufficiently to perform the task dependency assignment. They may have a lower title level than the ideal fit employee and will typically take more time to perform the assigned task. This type of employee is referred to as an alternative option (alternative effort factor time).

The user also has the ability to adjust the prioritization of the criteria previously outlined to alter the presentation sequence of available resources.

The user will then select the resource they want assigned to the project and presses the “submit” button on the web based application displayed on the user's personal computer via network connection to the Internet or intranet to confirm the assignment of the resources. These resources are assigned to the project and will not be part of the available resource pool for other project assignments over the same time period.

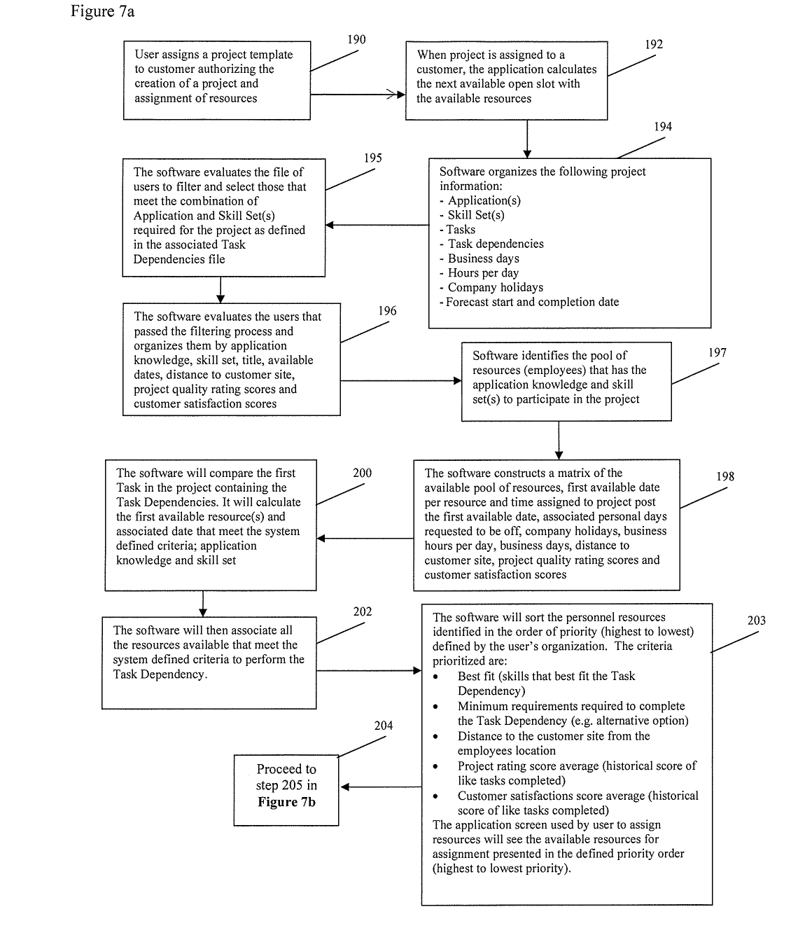

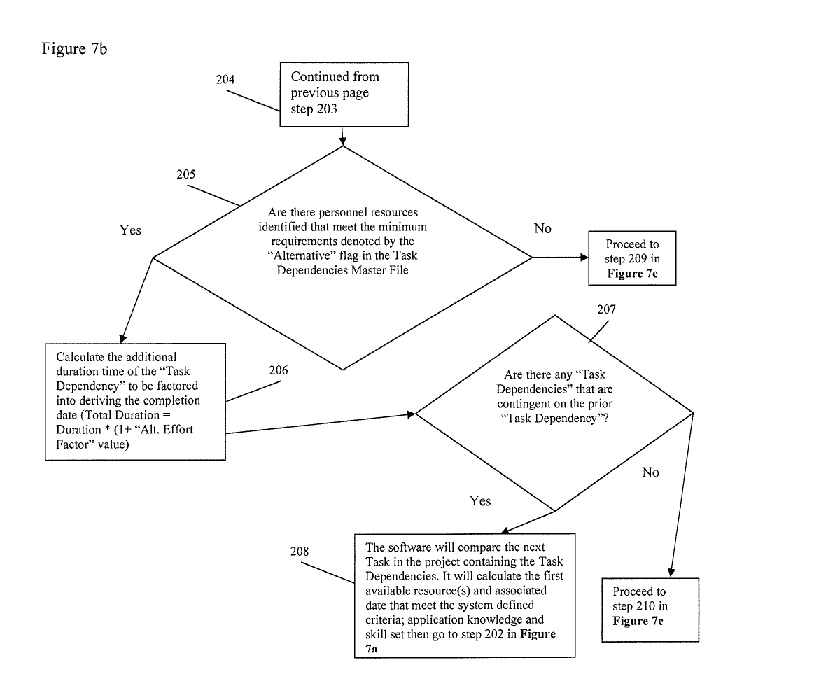

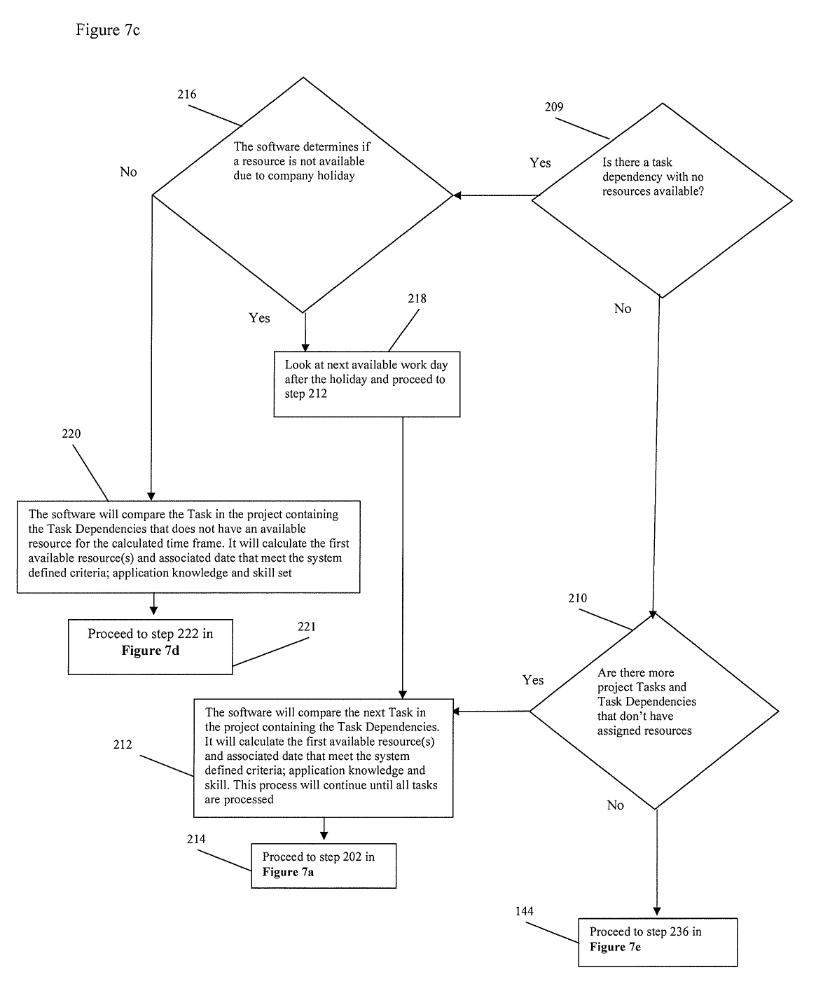

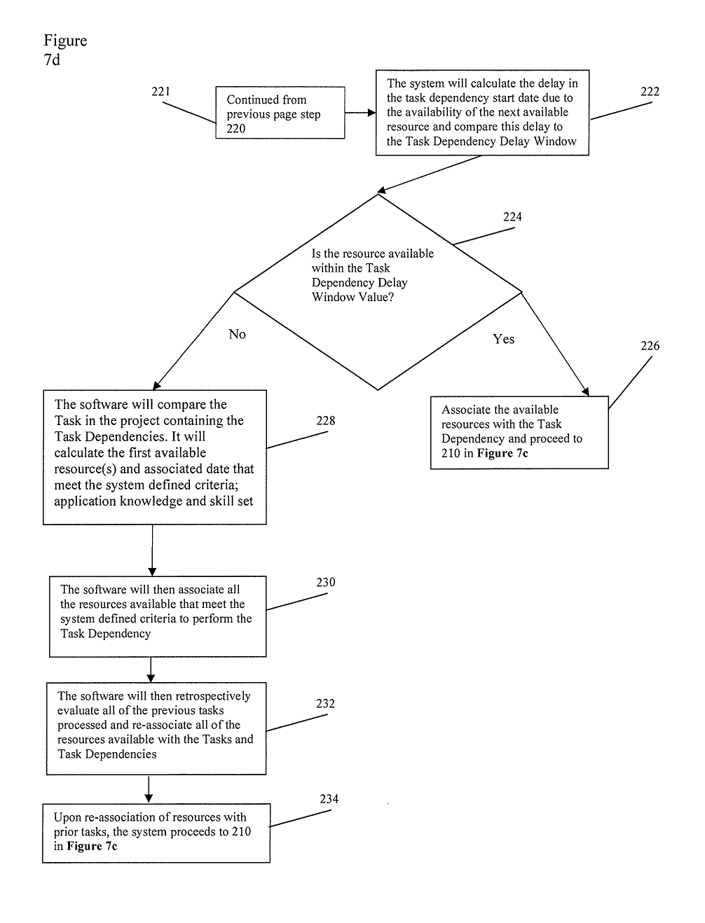

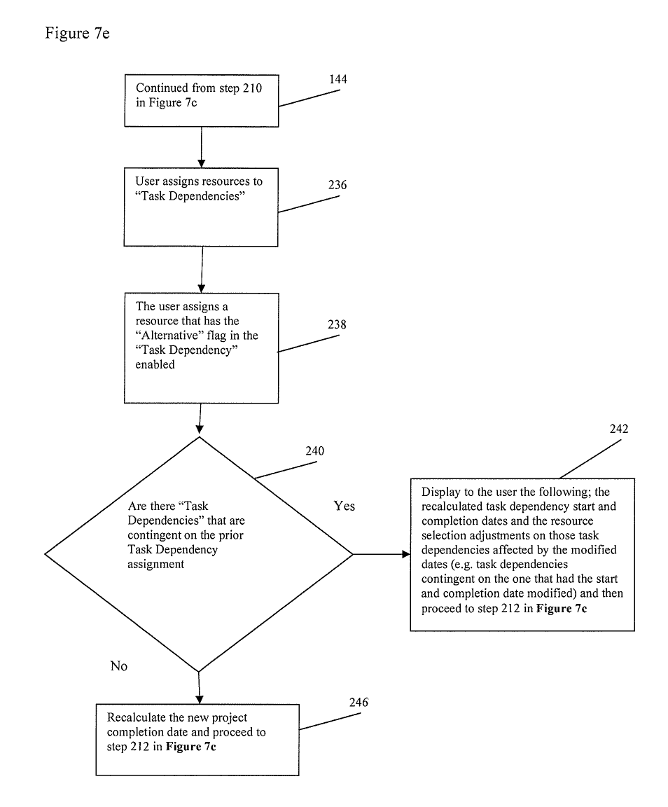

With reference to FIGS. 7a, 7b, 7c, 7d and 7e, a second embodiment or component is illustrated with the web based application software running on a centralized computer server executes a proprietary algorithm that accesses the data stored in the server in database tables illustrated in FIG. 2 allowing it to calculate and factor in additional project and/or resource time due to an employee's title and experience level that meets the minimum requirements to complete an assigned task though they may not be the optimal fit. In step 190 of FIG. 7a, the user assigns a project template to a customer authorizing the creation of a project and assignment of resources. In step 192, when the project is assigned to a customer, the application calculates the next available open slot with the available resources. In step 194, the software, or application, organizes the following project information: application(s), skill set(s), tasks, task dependencies, business days, hours per day, company holidays, and forecast start and completion date. In step 195, the software evaluates the file of users to filter and selects those that meet the combination of application and skill set(s) required for the project as defined in the associated task dependencies file. Then the software evaluates the users that passed the filtering process and organizes them by application knowledge, skill set, title, available dates, distance to customer site, project quality rating scores and customer satisfaction scores in step 196.

The software identifies the pool of resources (employees) that have the application knowledge and skill set(s) to participate in the project in step 197. Step 198 provides that the software constructs a matrix of the available pool of resources, first available date per resource and time assigned to project post the first available date, associated personal days requested to be off, company holidays, business hours per day, business days, distance to customer site, project quality rating scores and customer satisfaction scores. In step 200, the software compares the first task in the project containing the task dependencies. It calculates the first available resource(s) and associated date that meet the system defined criteria; application knowledge and skill set.

Next in step 202, the software associates all the resources available that meet the system defined criteria to perform the task dependency. In step 203, the software will sort the personnel resources identified in the order of priority (highest to lowest) defined by the user's organization. The criteria for prioritizing are: best fit (skills that best fit the task dependency), minimum requirements required to complete the task dependency (e.g. alternative option), distance to the customer site from the employees location, project rating score average (historical score of like tasks completed), and customer satisfactions score average (historical score of like tasks completed). The application screen used by the user to assign resources will show the available resources for assignment presented in the defined priority order (highest to lowest priority).

In FIG. 7b, the step 204 of FIG. 7a leads to step 205 where an inquiry is made as to whether there are personnel resources identified that meet the minimum requirements denoted by the alternative flag in the task dependencies master file. If not, the process jumps to step 209 in FIG. 7c. If yes, a calculation is performed at step 206 of the additional duration time of the task dependency to be factored into deriving the completion date (total duration=duration*(1+“alt. effort factor” value). The next step 207 is an inquiry made as to whether there are any task dependencies that are contingent on the prior task dependency. If so, the process proceeds to step 208 where the software will compare the next task in the project containing the task dependencies. It will calculate the first available resource(s) and associated date that meet the system defined criteria; application knowledge and skill set then go to step 202 in FIG. 7a. If no, then the process proceeds to step 210 in FIG. 7c.

An inquiry is made at step 209 FIG. 7c following a negative response to the inquiry at step 205 in FIG. 7b. The inquiry at step 209 evaluates is there a task dependency with no resources available? If not, an inquiry is made at step 210; are there more project tasks and task dependencies that don't have assigned resources? If not, the process jumps at step 236 to a process shown in FIG. 7e. If so, the process proceeds to step 212 where the software will compare the next task in the project containing the task dependencies. It will calculate the first available resource(s) and associated date that meet the system defined criteria; application knowledge and skill set. The following step 214 is where the process returns to step 202 in FIG. 7a. If the inquiry at step 209 is positive, the process goes to step 216. An inquiry is made at step 216 determines if a resource is not available due to company holiday. If the resource is available, then step 218 has the software application look at next available work day after the holiday and proceed to step 212. If the resource is not available, the process goes to step 220 where the software will compare the task in the project containing the task dependencies that does not have an available resource for the calculated time frame. It will calculate the first available resource(s) and associated date that meet the system defined criteria; application knowledge and skill set. The next step is 221 that jump's to step 222 in FIG. 7d.

In FIG. 7d, the step 221 of FIG. 7c leads to step 222 where the system will calculate the delay in the task dependency start date due to the availability of the next available resource and compare this delay to the task dependency delay window. In step 224, an inquiry is made: is the resource available within the task dependency delay window value? If so, step 226 associates the available resources with the task dependency and proceeds to step 210 in FIG. 7c. If not, step 228 provides that the application compares the task in the project containing the task dependencies. It will calculate the first available resource(s) and associated date that meet the system defined criteria; application knowledge and skill set. In step 230, the software then associates all the resources available that meet the system defined criteria to perform the task dependency. In step 232, the software will then retrospectively evaluate all of the previous tasks processed and re-associate all of the resources available with the tasks and task dependencies. Upon re-association of resources with prior tasks, at step 234 the system proceeds to step 210 in FIG. 7c.

FIG. 7e at step 236 is connected from step 144 in FIG. 7c. The user is presented a list of resources by priority associated with each respective task dependency. The user will assign the resources selected to the task dependency in step 236. The user also assigns a resource that has the alternative flag in the task dependency enabled in step 238. An inquiry is made as to whether there are task dependencies that are contingent on the prior task dependency assignment in step 240. If yes, proceed to step 242 and display to the user the following; the recalculated task dependency start and completion dates and the resource selection adjustments on those task dependencies affected by the modified dates (e.g. task dependencies contingent on the one that had the start and completion date modified) and then proceed to step 212 in FIG. 7c. If no, proceed to step 246 where the software program recalculates the new project completion date and proceed to step 212 in FIG. 7c.

The application screen, shown on a display device for example of a workstation, used by a user to assign resources will see the available resources for assignment presented in the defined priority order (highest to lowest priority).

The user is responsible for building the foundation information into the application to automate the calculation of resources available for possible assignments to project tasks comprised of task dependencies via the web based application software displayed on their personal computer through a network connection to the Internet or intranet. The application is engineered to understand that there is a range of resources (e.g. Analyst I, Analyst II, etc.) that have the skills and knowledge to perform a task dependency. A more senior title and experienced individual will typically be the best fit to perform a task dependency and will complete the task within the forecast time-frame. A less senior titled employee or an employee with a different title may be able to perform the task, though not complete it with the same level of proficiency as a more senior individual. Therefore, the software allows the user to build in additional project and time effort by a resource that can perform the assignment that meets the minimum requirements.

The foundational information to support the algorithm in automating the process of calculating the best fit available resources for an implementation project are the following.

A project master file—This is a file containing the project plan templates containing the name(s) of the application(s) that will be installed (e.g. for example an accounts payable application). The user can create an unlimited number of project master files through the web based application displayed on the user's personal computer via a network connection to the Internet or intranet. These project master files should be viewed as templates. They would correlate with the types of software and service installation projects contracted to their customers and are required to plan the assignment of implementation personnel.

A task master file—These are the tasks that are created and associated with a project through the web based application displayed on the user's personal computer via a network connection to the Internet or intranet.

A task dependencies master file—These are the lowest levels of definable work activities. Within the task dependencies the skill set required to perform the task is assigned from the data entered in the skill set master file and the associated position title through the web based application displayed on the user's personal computer via a network connection to the Internet or intranet.

A users file—This is a file that contains information about each user organization's employees. Within this file is an identification of the employee's application knowledge and skill sets through the web based application displayed on the user's personal computer via a network connection to the Internet or intranet.

A skill set master file—This is a file that contains the information defining the skill sets that each user has within their organization to implement applications and/or services. The skill sets are defined and entered by each user's organization and they are specific to that defining organization. This skill set is mapped to each user and task dependency. This is the data element in combination with application knowledge (defined in the application master file and associated to the user in the users file) that ensures the right users are mapped to the tasks they are qualified to perform through a combination of data filtering and matching based upon the rules of the web based application running on a computer server.

When a user has built the required data elements in the files listed, they will then be able to assign a project template to one or multiple customers. For example, the user's organization sells financial system software. One of the modules sold is accounts payable. The user will have an accounts payable project plan master file (template) built with the requirements of the implementation personnel application knowledge and skill set(s) required for each unit of work defined in the task dependencies master file.

The user wants to plan the installation of the accounts payable software post contract. The user will assign an accounts payable project template to the contracted customer identified in the application. The application will then automatically search the users file to identify the resources that meet skill set and application knowledge requirements to perform the task dependencies in the project plan. The software will then evaluate the earliest available date of all the resources identified and start associating the resources with the task dependencies and project tasks. Also any employee planned time off is factored into determining which resources are available to perform task dependencies. Through this process of associating resources to the project, the system will calculate start and end dates for each project task and task dependency. At this point, the system will calculate the modified end date if there are resources in the available pool that meet the skill set criteria and have an alternative effort factor value associated with the position title. The software will take the task dependency duration and multiply it by 1+the alternative effort factor value (e.g. 1+0.50) to derive the modified duration. The system will also factor into the calculation of the start and end dates are company holidays, working hours per day and working days per week. Therefore the end date for an Analyst Level III (a more senior analyst) may have an earlier end date and shorter effort for the task dependency calculated duration compared to an Analyst I level employee (less senior) with a later task dependency completion date and a longer duration effort.

The system will automatically present the user with a list of resource requirements associated with the project. Next to each resource requirement is a selection list of employees available to work on the project.

The order of employees presented to the user is significant in the context of the system calculating and identifying which employees are available that are the best fit to those meeting the minimum requirements for the project assignment. The criteria used to present the order of employees from best fit to meeting minimal requirements are the following combinations.
An employee has the skill set and application knowledge and position title combined that is the ideal fit for the task dependency assignment.
An employee that lives closest to the customer site requiring the least amount of travel time and expense.
An employee that has the highest quality score of project ratings for installations of the same type of project at prior customer sites.
An employee that has the highest average customer satisfaction scores with the same type of project from prior customer installations.
An employee that has the skill set and application knowledge sufficiently to perform the task dependency assignment. They may have a lower title level than the ideal fit employee and will typically take more time to perform the assigned task. This type of employee is referred to as an alternative option (an alternative effort factor time).

The user also has the ability to adjust the prioritization of the criteria previously outlined to alter the presentation sequence of available resources.

The user will then select the employees they want assigned to the project and presses the “submit” button in the web based application displayed on their personal computer to confirm the assignment of the employees. These employees that are assigned to the project and will not be part of the available resource pool for other project assignments over the same time period.

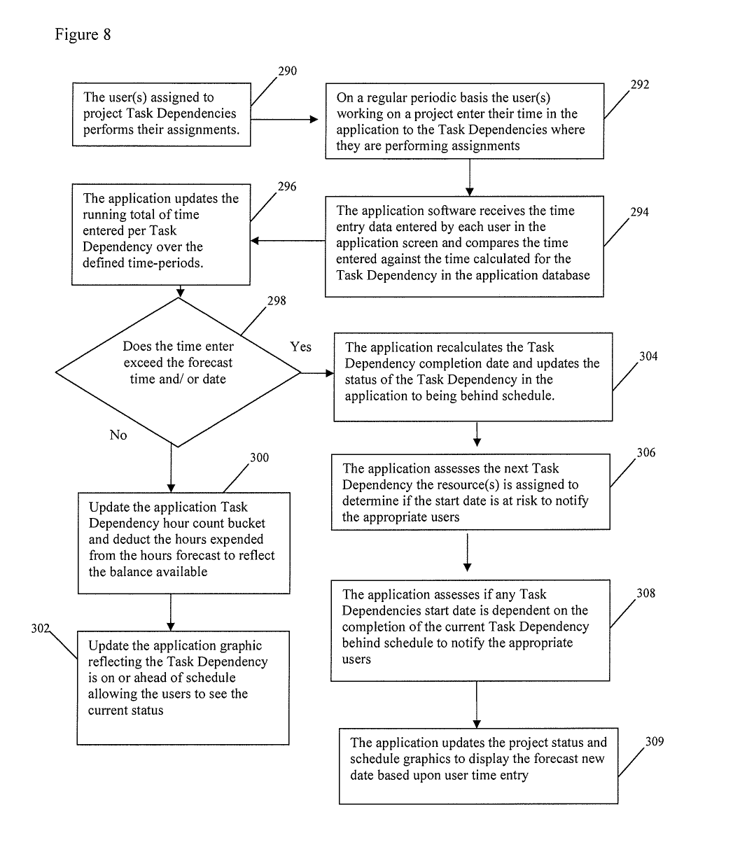

With reference to FIG. 8, the third embodiment is illustrated showing the application software dynamically running on a centralized computer server accesses the data stored in the server in database tables illustrated in FIG. 2 allowing it to recalculate task dependencies, task and project completion dates based upon user time entry in performing task dependencies.

FIG. 8 shows a process segment during which the software dynamically recalculates task dependencies, task and project completion dates based on user time entry in performing the task dependencies. This segment begins with step 290 wherein the user or users assigned to project task dependencies perform their assignments. In step 292, on a regular periodic basis the user or users working on a project enter their time in the application to the task dependencies where they are performing assignments. Step 294 provides that the application software receives the time entry data entered by each user in the application screen and compares the time entered against the time calculated for the task dependency in the application database. At step 296, the application updates the running total of time entered per task dependency over the defined time-periods. An inquiry is made at step 298 as to whether the time entered exceeds the forecast time and/or date. If not, step 300 provides that an update is made to the application task dependency hour count bucket and a deduction of the hours expended from the hours forecast is performed to reflect the balance available. In step 302, an update of the application graphic is made reflecting that the task dependency is on or ahead of schedule allowing the users to see the current status.

If at step 298 the determination is affirmative that the time exceeds the forecast, the step 304 provides that the application recalculates the task dependency completion date and updates the status of the task dependency in the application to “behind schedule.” At step 306 the application assesses the next task dependency to which the resource is assigned to determine if the start date is at risk in order that the appropriate users may be notified. In step 308, the application assesses if any task dependency's start date is dependent on the completion of the current task dependency which is behind schedule in order that the appropriate users may be notified. At step 309 the application updates the project status and schedule graphics to display the forecast new data based upon the time entered by the user.

The software will factor in user availability when there are shifts in task dependency dates either forward or backward. It will also factor in holidays, employee days off, user title and skill set and dynamic changes in project scope. The end result is the software will provide the users information on task dependencies, tasks and project date adjustments and user schedule conflicts. This allows the user to make the appropriate and necessary project staffing adjustments to ensure the target billable utilization of users is being met if not exceeded while preventing user conflicts adjustments negatively impacting other projects.

The user has built project templates and assigned them to customers that have contracted for services. Employees have been assigned to these projects and they are updating their time in the web based application displayed on their personal computer (typically on a weekly basis), as task dependencies are being performed. When the user enters their time entry, the application compares the actual time entered to the amount in the project plan. It will display graphically in the application indicators if task dependencies are on track, running behind or ahead of schedule. These dynamic adjustments may or may not affect the project completion date. The system will advise users if the project is on time or the new forecast completion date based upon the current progress. It also graphically displays the new forecast completion date compared to the actual completion date originally planned when the resources were assigned. Therefore, the user can make the appropriate adjustments to get the project back on track or make adjustments to the employees planned on upcoming projects that may be impacted due to the current project running behind or ahead of schedule.

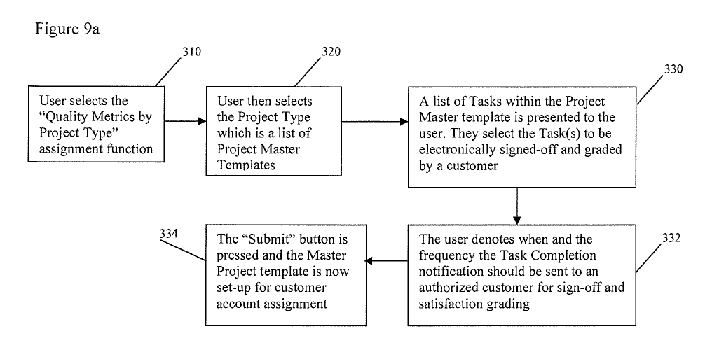

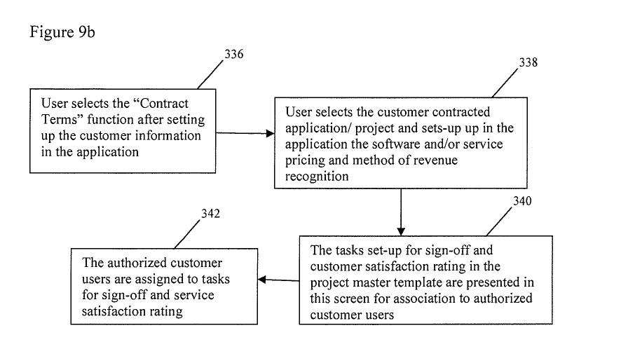

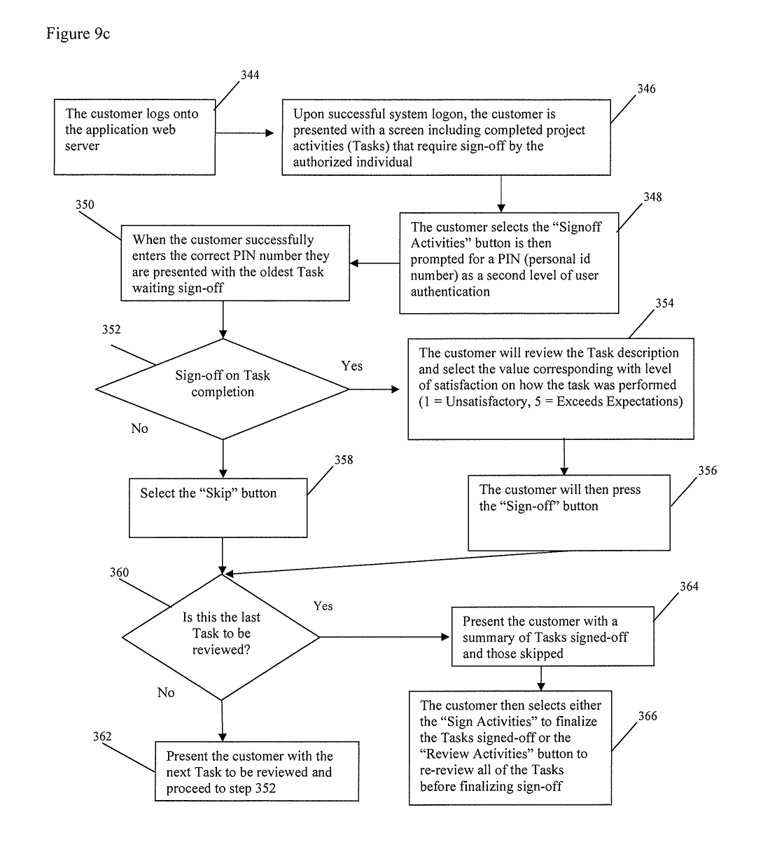

With reference to FIG. 9a, a fourth embodiment of a method and software that dynamically recalculates task dependencies, task and project completion dates bases on user time entry in performing task dependencies. The method and software reflects the application software running on a centralized server that accesses the data stored in the server in database tables illustrated in FIG. 2. In FIG. 9, a step 310 provides that a user selects the “quality metrics by project type” assignment function. In step 320 the user then selects the project type which is a list of project master templates. Step 330 provides that a list of tasks within the project master template is presented to the user. The user selects the task(s) to be electronically signed-off and graded by a customer. At step 332 the user denotes when and the frequency of the task completion notification should be sent to an authorized customer for sign-off and satisfaction grading. Thereafter at step 334 the user submits the entry for example by pressing the submit button on the display and the master project template is now set-up for customer account assignment.

In FIG. 9b at step 336 the user selects the contract terms function after setting up the customer information in the application. In step 338 the user selects the customer contracted application and/or project and sets-up up in the application the software and/or service pricing and method of revenue recognition. The tasks which are set-up for sign-off and a customer satisfaction rating in the project master template are presented in this screen for association to authorized customer users at step 340. In step 342 the authorized customer users are assigned to tasks for sign-off and service satisfaction rating.

The process of FIG. 9c provides that the customer logs onto the application web server at step 344. In the following step 346, upon successful system logon the customer is presented with a screen including completed project activities (tasks) that require sign-off by the authorized individual. Step 348 provides that the customer selects the signoff activities button is then prompted for a PIN (personal id number) as a second level of user authentication. Following the log in, at step 350 when the customer has successfully entered the correct PIN number the customer is presented with the oldest task waiting sign-off. The decision step 352 determines whether the customer signs-off on the task completion. If so, the customer will review the task description and select the value corresponding with level of satisfaction on how the task was performed (for example 1=unsatisfactory, 5=exceeds expectations) at step 354. At step 356 the customer will then press the sign-off button.

If at decision step 352 the answer is negative, the step 358 permits the user to select the skip button. Either way that the decision 352 goes, the process proceeds to step 360, which the method and application checks in the system database tables, is this the last task to be reviewed? If not, at step 362 the customer is presented with the next task to be reviewed and the process loops back to step 352. If so, the step 364 presents the customer with a summary of tasks that are signed-off and those that were skipped. At step 366 the customer then selects either the sign activities command to finalize the tasks signed-off or the review activities button to re-review all of the tasks before finalizing sign-off.

This allows the method and apparatus to build a cohesive and interactive relationship between the user's organization and their customers. Also with accounting regulations and Sarbanes Oxley rules, the method of acceptable means to recognize software revenue and services has been rigorously defined. The application has built-in functionality to support Generally Accepted Accounting Principles (GAAP) revenue recognition practices for software and/or implementation services rendered. To address the regulatory accounting requirements in conjunction with developing a cohesive and interactive relationship between the user's organization and their customers, functionality has been built into the application having the appropriate and authorized customer electronically sign-off on completed tasks with integrated customer satisfaction performance ratings.

This functionality supports when software and services are recognized, the percentage or dollar amount of software and services to be properly recognized based upon how the software and/or service contract is structured. This application capability also supports the user to demonstrate to accounting auditors their customers have accepted the software and services rendered to-date based upon their electronic sign-off of the project task.

The integrated customer satisfaction performance rating is required when a user signs-off on the completion of a task. This allows the user to monitor the customer satisfaction of software and/or services rendered, measure the performance of the individuals delivering the services and support the detection of customer satisfaction issues quickly. Therefore, the user can address the concerns with the customer and make the appropriate adjustments to address any dissatisfaction with the software and services that can ultimately translate into payment and or project delays.

The customer satisfaction ratings also supports the user by identifying personnel that are strong performers in delivering services or individuals that need additional coaching or training. Each individual employee can monitor their overall performance score and determine how well they are performing in the eyes of the customer and their employer. Therefore, they can make adjustments in their performance giving them the ability to improve their scores when and where the situation deems it necessary.

This functionality is delivered through the web based application running on the centralized server allowing the user interacting with the computer on their desktop displaying the application via a network connection to the internet or intranet to define within a project template which project tasks when completed will generate a notification to the authorized customer personnel to electronically sign-off on the task and rate the performance of the services delivered. Within these parameters the user can define when the request is generated for sign-off. For example, is it post-completion of the task or on a regular periodic basis and how frequently (e.g. long duration tasks such as “weekly project update review.”) The application also supports the definition of the sequence the task should be electronically signed-off and customer satisfaction rated and by whom. Therefore, a task can be electronically signed off by one or multiple people and graded either in a serial or parallel manner.

When this information is set-up, as tasks are completed a message is placed in the customer “Signoff Activities” in-box on the application waiting for the customer to review this information. When they log-onto the web based application displayed on their personal computer, the user is presented with a list of tasks awaiting their sign-off. When the customer selects this option, they are required to enter a second security level of identification which is a PIN number. When the correct PIN number is entered, the customer is then presented with each completed task. The completed tasks by default are presented in the order of oldest to most recently complete.

The customer is then are required to rate the quality of the services associated with each task before they can electronically sign-off on the task. If the customer does not want to sign-off on the task at that time, they can skip it by selecting the skip command and proceed to reviewing the next completed task. When the customer has finished going through all of the completed tasks either electronically signing-off on them or skipping them, they are presented with a summary screen. The information presented allows the customer to re-review the tasks or finalize electronically signing those tasks that were authenticated upon review. The customer will select the submit button and the application will electronically authenticate the tasks, mark them as a completed assignment for the customer and update the application database denoting the tasks as completed per the user. The application will also take the customer satisfaction scores for each task and assign them to the responsible user that performed the services associated with the task. This allows the application to grade and report an individual's job performance for a particular customer project and the average performance for the same task across multiple projects. The grading score for customer satisfaction is a Likert scale from 1 to 5 with the lowest number (1) denoting an unacceptable performance to the highest value (5) denoting service that exceeds expectations.

In parallel to the application requesting customer satisfaction score ratings for a task to reflect the customer's perception of the service, the software also tracks satisfactory performance of the employee's performance from an employer perspective. The application tracks if a user is completing assigned tasks on-time, ahead of schedule or behind schedule. This is also a grading on a Likert scale from 1 to 5 with the middle value denoting a task is being completed on-time and the lowest value denoting the task was completed significantly behind schedule (e.g. more than 100% longer than planned) and the highest value denoting a task was completed way ahead of schedule (e.g. more than 50% faster than planned). This information in conjunction with the integrated customer satisfaction ratings allows the user to review the performance of employees. They can objectively rate their performance, quickly identify employee performance issues requiring intervention and identify high performing employees that can be interviewed to learn their best practices.

As all of the customers electronically sign-off on the completion of tasks, this information is recorded in the application database. This update triggers the forecast of revenue that can be recognized for a specific project consistent with GAAP accounting rules and is auditable for accounting auditors. The user can easily review the satisfaction of the customer for services rendered with a particular project, objectively evaluate employees' performance, forecast revenue recognition for a particular time-period and substantially support what amount of revenue is recognized for a particular project at a specified point-in-time compliant with GAAP accounting and Sarbanes Oxley rules.

With reference now to FIG. 10, the process flow for assigning a project quality score to a user as they complete assigned task dependencies is shown. In step 370, a user assigns resources to task dependencies. In step 372 task dependency's have a defined start and end date calculated by the present method and are locked in assignment when project is confirmed. In step 374, as a user's organization staff works on the project they enter time to the assigned task dependencies. In step 376 the software tracks when users complete assigned task dependency against the calculated date. In step 378, the software assigns the user a project quality score, on a Likert scale (1—poor, 3—on-time, 5—exceeded on-time completion), based upon task dependency completion date compared to the assigned date. In step 380 the software records the project quality score associated with each user and associated task dependency in a table to calculate each individual's project quality score. In step 382 the software calculates a user's project quality score mean average as task dependencies are completed and stores this value in their user file.

In FIG. 11, the present method and apparatus uses parameters defined in a project plan template (application knowledge, skill set requirements, etc.) to build an algorithm in evaluating the pool of employees to identify the resources that meet the defined requirements. The quantity of application knowledge of the employees, the skill sets of the employees, and their availability is filtered by the application knowledge requirements of the project, the skill set requirements of the project and the projected dates and durations of the tasks. Applying knowledge such as the location of the employee relative to the customer, the project quality score and the customer satisfaction score, the present method and software achieves a prioritized list of available resources for the project. These resources are then presented on a user's personal computer running the web based application in the order of priority from best fit to meet the minimal requirements guiding the manager in making the decision of assigning personnel to the project.

In FIG. 12a, the present method and apparatus uses the information stored in the customers users database file 36 in FIG. 2 as an input for comparing against each task dependency in a project. This enables the application software running on the servers to identify the resources for further evaluation and subsequent presentation to a manager for assignment. The information in this figure is a graphical representation of the personnel information (also referenced to as matrix pool of resource data or pool of employees).

In FIG. 12b, the present method and apparatus uses the information stored in the customers projects file database table 40 of FIG. 2 as an input in comparing the requirements of the task dependencies of the project illustrated in 12b against the personnel information in database file 36 of FIG. 2. This provides the application software running on the servers to identify, filter and create a prioritized list of resource candidates for selection by the manager as illustrated in FIG. 12c.

In FIG. 12c, the present method and apparatus uses the inputs from customers users database table 36 of FIG. 2 against the task dependencies requirements associated with the project in database table 40 FIG. 2 to identify the list of resources for further evaluation by the application running on the computer servers. The information is subsequently presented to a manager in a prioritized list associated with each task dependency allowing them to select the resources for assignment as graphically represented in this figure.

Thus, there is shown and described a method and apparatus for managing projects. The present method and apparatus finds particular advantage in management of a plurality of simultaneous and/or overlapping project in a large organization. In one application, the projects are software writing projects such as writing of an accounts payable program for a large organization, although the teachings of the present method may be applied to many different types of projects. The present method and apparatus utilizes machines, such as computer devices and systems, processors, tangible computer readable media, user interface devices, network communications devices and other devices to carry out the method. Software and/or firmware are executed on the computer devices to provide a programmed computer device or processor for carrying out the method steps. The software may be programmed in C++, Java, or other programming languages.

Although other modifications and changes may be suggested by those skilled in the art, it is the intention of the inventors to embody within the patent warranted hereon all changes and modifications as reasonably and properly come within the scope of their contribution to the art.

We claim:

1. A method for project management, comprising the steps of:
receiving a proposed project in a computer system including receiving a proposed start date for the project;
creating tasks for the project;
evaluating personnel as resources for working on tasks of the proposed project using a matching algorithm running on the computer system;
calculating a prioritized list of the resources that fit requirements of the tasks of the project using the computer system, said prioritized list taking into account availability, distance, skills and knowledge of the resources relative to the tasks of the project;
assigning resources to the proposed project;
forecasting a completion date for the proposed project based on the assigned resources using the computer system;
initiating work on the project;
tracking time worked on the project by the resources assigned to the project using the computer system;
updating the forecasted completion date information during project based on the tracked time using the computer system;
dynamically calculating availability of the resources during the project using the computer system; and
completing the project.

2. A method as claimed in claim 1, further comprising the steps of:
measuring customer satisfaction of work on the project;
measuring employee performance of work on the project; and
reporting personnel performance metrics.

3. A method as claimed in claim 1, further comprising the step of:
providing an automated sign off of the project after completion of the project.

4. A method as claimed in claim 1, further comprising the steps of:
reporting financial performance of the project.

5. A method as claimed in claim 4, further comprising the step of:
forecasting revenue of the proposed project prior to completion of the project.

6. A method as claimed in claim 5, further comprising the step of:
reporting a difference between forecast revenue and actual revenue for a project.

7. A method as claimed in claim 1, further comprising the step of;
reporting personnel performance during work on the project.

8. A method as claimed in claim 1, further comprising the steps of:
assigning the resources to future projects to be worked following completion of the current project;
updating at least one of start dates and assigned resources of the future projects as changes occur in the tracked time of the current project.

9. A method as claimed in claim 1, further comprising the step of:
automatically modifying a timeline of the project upon a change in availability of the assigned resources.

10. A method as claimed in claim 9, wherein said modifying includes holding the project and further comprising the step of:
automatically deploying the assigned resources to other projects while the current project is on hold.

11. A method as claimed in claim 1, further comprising the step of:
generating a matrix of a pool of available resources for the project.

12. A method as claimed in claim 1, further comprising the step of:
confirming the project with the assigned resources using the computer system.

13. A method as claimed in claim 1, further comprising the steps of:
re-evaluating the availability of assigned resources upon changes to the project timeline; and
assigning new resources as needed.

14. A method as claimed in claim 1, further comprising the step of:
considering company holidays, personal time off, business hours per day, business days, and distance between resource and customer site in calculating the project timeline and resource availability.

15. A method as claimed in claim 1, further comprising the steps of:
determining that no resources meeting a minimum criteria are available at the proposed start date; and
calculating a start date for the project based on a first availability of resources that meet the minimum criteria.

16. A method for project management of a plurality of projects, comprising the steps of:
generating a project master template for each of the projects, including
receiving employee information on a computer system, and
receiving tasks and task dependencies for the project on the computer system, calculating a next available slot for the plurality of project using the computer system;
assigning employees as resources to the tasks and task dependencies of the projects;
initiating work on a first of the projects using the assigned resources to complete the tasks and task dependencies;
receiving user input on the first project on the computer system;
monitoring progress of the first project using the computer system;
dynamically updating start dates and assigned resources of the other projects as changes occur in the progress of the first project; and
upon completion of the first project, reassigning resources used in the first project to a next project using the computer system.

17. A method for managing a project of an organization, comprising the steps of:
receiving information of the organization on a computer system;
receiving information of employees of the organization on the computer system, said information of the employees including information on days the employee is available to work on the project;
receiving information on skills and knowledge of the employees on the computer system;
receiving a request for a project;
creating a master project template on the computer system;
creating tasks and task dependencies for the project;
assigning task dependencies to the tasks and assigning tasks to the project template on the computer system;
assigning the employees as resources to the task dependencies on the computer system;
initiating the project using the resources;
receiving input of time from the resource as the task dependencies are completed on the computer system;
receiving a sign-off of the project on the computer system after the project is completed.

18. A method as claimed in claim 17, wherein said step of receiving information of employees include receiving employee location information including zip/postal code information; and
said step of assigning employees as resources to the task dependencies includes considering location of the employee relative to a site where the task dependency work is to be performed.

19. A method as claimed in claim 17, further comprising the step of:
prioritizing the resources by considering fit of skills of the resource to the skills required for the task dependency, distance to site where work is to be performed, and historical score of like tasks performed.

20. A method as claimed in claim 17, further comprising the steps of:
determining contingencies of the task dependencies on one another; and
calculating a project timeline based on skill levels of resources assigned to task dependencies and durations of contingent task dependencies.

21. A method as claimed in claim 17, further comprising the step of:
evaluating a pool of available resources that have the skills to participate in the project.

22. A method as claimed in claim 17, further comprising the step of:
constructing a matrix including available resources, first available date per resource, personal days requested to be off per resource, distance to work site, project quality rating scores, and customer satisfaction scores.
